(19) United States
(12) Patent Application Publication
(10) Pub. No.: US 2008/0307600 A1
(43) Pub. Date: Dec. 18, 2008

(54) System and method for mirror wiper

(76) Inventor: Kevin Michael Scott, Littleton, MA (US)

Correspondence Address: Maureen Stretch, 26 Charles St, Natick, MA, 01760, US

(21) Appl. No.: 11/818,426

(22) Filed: Jun. 14, 2007

(51) Int. Cl. B60S 1/56

(52) U.S. Cl. 15/250.003

(57) ABSTRACT

A system for wiping an external mirror on a vehicle.

### BACKGROUND OF THE INVENTION

1. Technical Field

The present invention relates generally to wipers for mirrors on vehicles and more specifically to wipers for external mirrors.

2. Background

Trucks, buses, and similar vehicles often use external mirrors to provide the driver with side and rear views of traffic. Unlike most windshields for such vehicles, the mirrors usually are not provided with wiper systems for cleaning. Consequently, in rain and poor weather, the driver's side and rear vision can be obscured if the mirrors are covered with rain, snow, or road debris.

It is an aspect of the present invention that it provides a wiper system for such mirrors which can either be retrofitted to an existing mirror or built as part of a new mirror assembly.

### BRIEF DESCRIPTION OF THE DRAWINGS

FIG. 1 is a schematic drawing of an external mirror equipped with an embodiment of the present invention.

FIG. 2 is a schematic drawing of a rear view of an embodiment of the present invention.

FIG. 3A is a schematic drawing of a wiper arm of an embodiment the present invention, taken from a top view.

FIG. 3B is a schematic drawing of a protruding extension of a slidable puck of an embodiment of the present invention.

FIG. 4 is a schematic drawing of a vehicle dashboard using an embodiment the present invention.

### DETAILED DESCRIPTION OF THE INVENTION

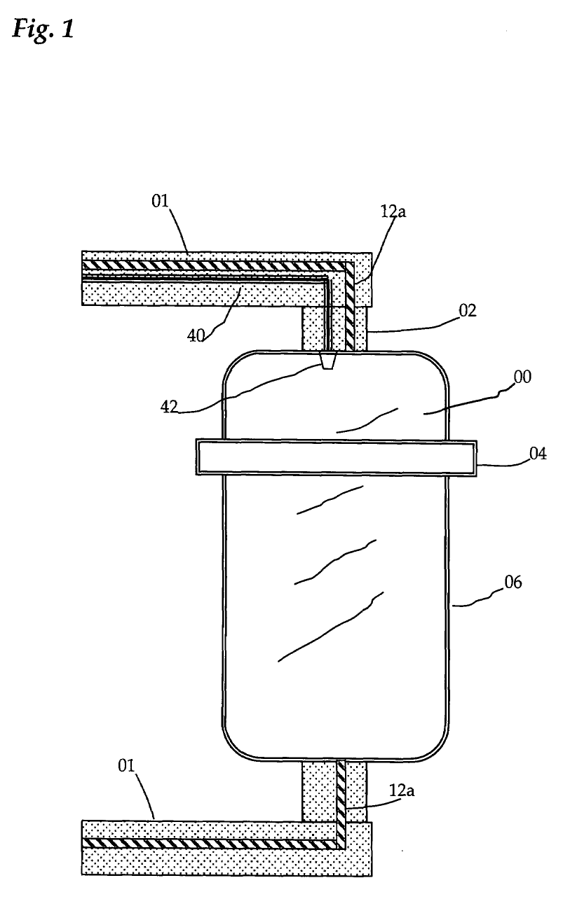

In FIG. 1, a schematic view of an external mirror equipped with an embodiment of the present system is shown. In this embodiment, mirror 00 is attached to the truck or similar vehicle, by any of a number of conventional supports 01. In many of the newer vehicles of this type, mirror 00 is enclosed in a housing 06 for a more aerodynamic shape. The embodiment shown provides a piston 02, mounted on the rear of housing 06, to move a wiper arm 04 (housing a wiper blade) over the front surface of mirror 00. Those skilled in the art will appreciate that retrofitting embodiments of the present invention to an older mirror can also be done by adding a housing 06, to an older mirror 00 or adding a piston 02 and wiper arm 04 to other types of mirrors.

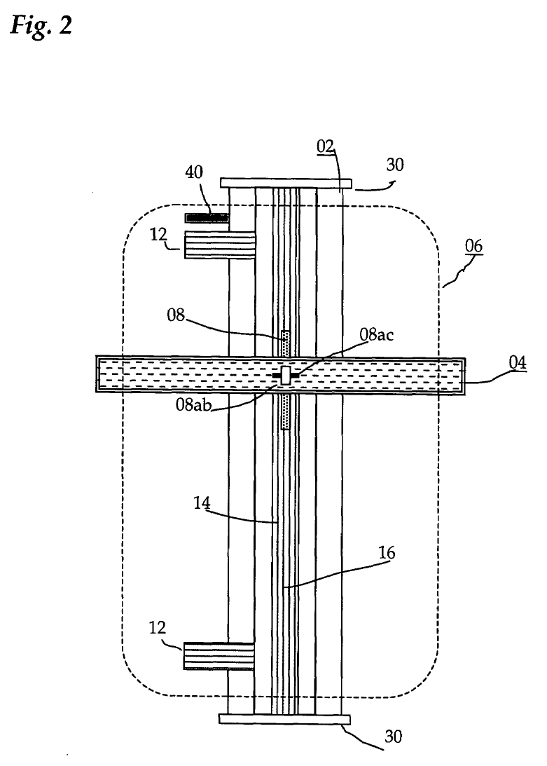

Turning now to FIG. 2, a rear view of mirror 00 is shown, with housing 06. In this embodiment, piston 02 is affixed to housing 06 by any of a number of conventional means, such as bolting, welding, pop riveting, among others. In this embodiment, the present invention is added to the mirror as an aftermarket or retrofit option. Those skilled in the art will appreciate that piston 02 can also be manufactured as part of housing 06 if the invention is incorporated in the manufacture of the mirror itself.

Still in FIG. 2, piston 02 has a slidable puck 08 included in it. Slidable puck 08, in turn, is connected to wiper arm 04, so that as slidable puck 08 moves up and down in the vertical plane, wiper arm 04 moves with it. In the embodiments shown, wiper arm 04 is shaped to encompass housing 06 and the front surface of mirror 00 in a wraparound fashion. In the embodiments shown, piston 02 is part No. BWC3PB2R, manufactured by Sprague Devices, Inc., a company of the Commercial Vehicle Group, Inc. (“CVG”), with headquarters at 6530 W. Campus Oval, New Albany, Ohio 43054. Piston 02 is preferred for the embodiments shown because slidable puck 08 moves inside the housing of piston 02—a solid, rigid housing. Since slidable puck 08 is contained inside piston 02 and is prevented from leaving the housing at either end of its stroke, it provides an even stroke and movement to wiper arm 04.

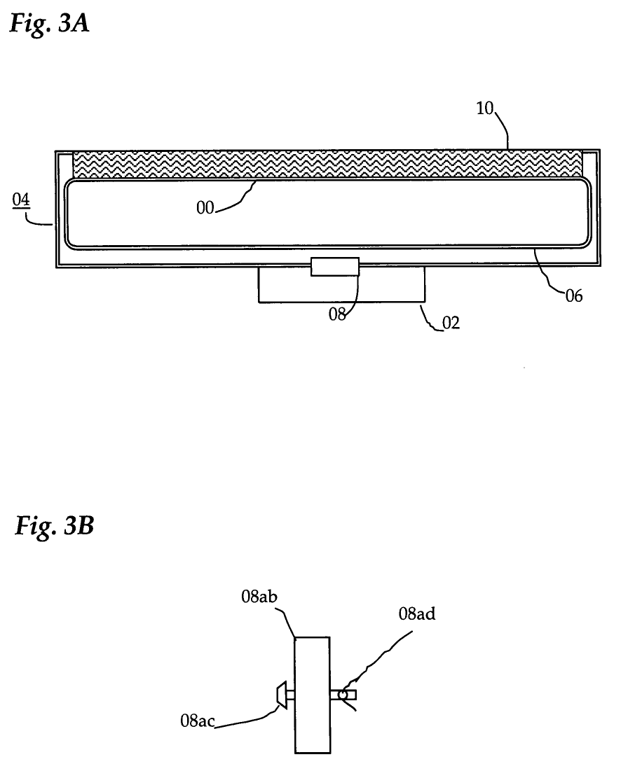

In addition, and turning now to FIG. 3B, slidable puck 08 of the above mentioned piston also includes a protruding extension 08ab, which fits into an opening or ear notch of wiper arm 04. Protruding extension 08ab of slidable puck 08 also includes a pinhole opening 08ae, through which a clevis pin 08ad can be inserted and held in place with a cotter pin 08ae. Those skilled in the art will appreciate that other pistons structured in a similar way could be used without deviating from the spirit of the present invention.

With reference now to FIG. 3A, wiper arm 04 is shown from a top view, encompassing housing 06 of mirror 00. In this embodiment, wiper arm 04 includes wiper blade 10, which is placed inside wiper arm 04 so that wiper blade 10 comes into contact with the front surface of mirror 00. Thus, when wiper arm 04 is moved by piston 02, wiper blade 10 sweeps over the front surface of mirror 00 to clean it of rain, snow or other debris. In the embodiments shown, wiper blade 10 is made of typical elastomeric material used in windshield wiper blades, such as rubber or plastic. In the embodiments shown, wiper blade 10 is a conventional flat stock straight steel-backed rubber blade, such as those made by Velvac, Wagner, and others.

Still in FIG. 3A, wiper arm 04 is made of Teflon, but those skilled in the art will appreciate that it can be made from any material which is sufficiently rigid to keep the shape of wiper arm 04 square. Aluminum, steel, certain plastics and other rigid materials could be used without deviating from the scope of the present invention. In the embodiments shown, the rigid material with Teflon interior lining or Teflon sides is used not only to keep the shape of wiper arm 04 square, but also to enable wiper arm 04 to slide smoothly over mirror housing 06. Those skilled in the art will appreciate that if Teflon or a similarly smooth material is not used for a lining or as part of the sides, idler wheels can be inserted at either side inside wiper arm 04 to enable it to move smoothly over mirror housing 06 without deviating from the spirit of the present invention. Those skilled in the art will appreciate that a number of materials and combinations can be used to impart sufficient rigidity to wiper arm 04 to keep it square, while also enabling it to slide smoothly over mirror housing 06.

Also in FIG. 3A, wiper blade 10 is attached to wiper arm 04 in the embodiments shown through conventional fittings or notches in the face of wiper arm 04.

With reference now to FIG. 2, in the embodiment shown, piston 02 includes a vertical aperture 14 encasing spring steel member 16. Slidable puck 08 is thus able to move up and down spring steel member 16 inside aperture 14. As seen in FIG. 2, slidable puck 08 is affixed to wiper arm 04 so that movement of ridable puck 08 through aperture 14 along spring steel member 16 also imparts movement up and down to wiper arm 04. In the embodiments shown, wiper arm 04 has an ear notch to accommodate slidable puck 08 as described above. Wiper arm 04 is shaped to fit in or on protruding extension 08ab of slidable puck 08. Those skilled in the art will appreciate that wiper arm 04 can be shaped in a number of ways to accommodate slidable puck 08.

Still in FIG. 2, in the embodiment shown, piston 02 also has air inlets 12 inserted therein. In the embodiments shown, air inlets 12 are positioned near the top and bottom of piston 02, so as to direct movement of slidable puck 08 either up or down. In the embodiments shown, piston 02 is an air piston such as part No. BWC3PB2R, manufactured by Sprague Devices, Inc., a company of the Commercial Vehicle Group, Inc. (“CVG”), for use in air-powered windows. Thus air is supplied by piston 02 to move slidable puck 08 either up or down. In the embodiments shown, piston 02 is self-contained—that is, the piston itself cannot escape from its housing and is constrained by plastic caps 30 at the top and bottom.

Referring now to FIG. 1, in an embodiment shown, a fluid line 40 can be affixed to or inserted within support 01, to carry windshield washer fluid to nozzle 42, so that fluid can be sprayed across the surface of mirror 00, in conjunction with the wiping motion of wiper arm 04 of the present invention.

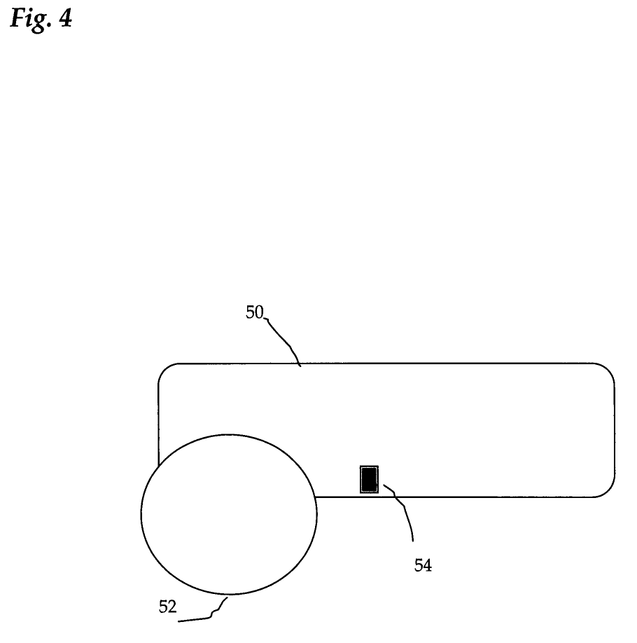

With reference now to FIG. 4, a schematic drawing of a vehicle interior is shown, having a dashboard 50 behind a steering wheel 52. In this embodiment, wiper arm 04 can be controlled by switch 54, mounted on dashboard 50. In its simplest embodiment, switch 54 is a simple toggle switch, which forces air through an air supply connected to the air inlets in piston 02, to move wiper arm 04 for as long as you hold the switch down. Those skilled in the art will appreciate that you could also have switch 54 operate a valve mechanism similar to those used for opening and closing air powered windows. As will be apparent to those skilled in the art, this, in turn, could be constructed so that the switch can be set to keep wiper arm 04 moving up and down in continuous movement, once activated.

1. What is claimed is a system for wiping an external mirror on a vehicle, comprising:
a mirror support for housing the external mirror;
a piston responsive to a movement source supplied along the mirror support, the piston being mounted on the rear surface of the external mirror;
a slidable puck having a protruding extension, the slidable puck being inserted in the piston and movable, with the piston, in response to the movement source; and
a wiper arm connected to the slidable puck, the wiper arm including an elastomeric wiper blade, the wiper arm extending laterally in opposing directions away from the slidable puck to encompass both the rear and front surfaces of the external mirror so that movement of the slidable puck imparts movement to the wiper blade upon the front surface of the external mirror.

2. The system of claim 1, wherein the movement source further comprises compressed air piped through the mirror support.

3. The system of claim 2, wherein the movement source further comprises an air inlet connecting the compressed air to the piston.

4. The system of claim 3, wherein the air inlet further comprises an air line disposed at each end of the piston.

5. The system of claim 2, wherein the compressed air is provided by a compressed air source inside the vehicle.

6. The system of claim 1, wherein the mirror support further comprises a fluid line for dispensing washer fluid over the mirror.

7. The system of claim 1, wherein the vehicle includes a switch for activating the wiper blade.
